(19) United States
(12) Patent Application Publication
(10) Pub. No.: US 2012/0259515 A1
(43) Pub. Date: Oct. 11, 2012

(54) METHOD FOR ACTIVATING AND/OR CONTROLLING AT LEAST ONE REVERSIBLE RESTRAINING DEVICE

(76) Inventors: Heiko Freienstein, Weil Der Stadt (DE); Thomas Lich, Schwaikheim (DE); Gian Antonio D'Addetta, Stuttgart (DE)

(21) Appl. No.: 13/501,607

(22) PCT Filed: Nov. 30, 2010
(86) PCT No.: PCT/EP2010/068550

§ 371 Date: Jun. 26, 2012

(30) Foreign Application Priority Data
Dec. 2, 2009 (DE) 10 2009 047 373.4

(51) Int. Cl. B60R 21/0132

(52) U.S. Cl. 701/46; 701/45

(57) ABSTRACT

A method for activating and/or controlling at least one reversible restraining device as a function of a danger situation that is detected ahead of time, the danger situation being detected ahead of time by evaluating sensor signals that are provided by at least one sensor unit, and an evaluation-control unit for implementing the method and an occupant protection system having such an evaluation and control unit. Such a danger situation is detected if an evaluation of the sensor signals determines that the vehicle has departed from the roadway, a directional angle being ascertained at which the vehicle has departed from the roadway, and the at least one reversible restraining device being activated and/or controlled as a function of the ascertained directional angle.

### FIELD OF THE INVENTION

The present invention relates to a method for activating and/or controlling at least one reversible restraining device, a corresponding evaluation and control unit for implementing the method for activating and/or controlling at least one reversible restraining device, and an occupant protection system having such an evaluation and control unit.

### BACKGROUND INFORMATION

German Patent Application No. DE 10 2004 058 814 A1 describes for example a method and a device for restraining an occupant on a vehicle seat. When detecting a critical driving state, the described method forcefully pulls the occupant back into the vehicle seat by a belt tensioner and then restrains the occupant in the pulled-back position by a restraining force. The described device for restraining the occupant on the vehicle seat during a critical driving state includes a safety belt, a unit for the predictive detection of a dangerous driving state and an occupant position detection, a force being applied to a belt tensioner upon detecting a dangerous driving state, and the occupant thereby being pulled into the vehicle seat, the occupant being held in the pulled-back position on the vehicle seat by a restraining force. For this purpose, the critical driving state is detected by monitoring the steering angle, the distance to an object, the relative speed, the vehicle deceleration, the yaw angle, the yaw rate, the yaw acceleration, the speed of the host vehicle, the steering angle, pronounced changes in direction and/or angles of inclination or any combination of these parameters.

### SUMMARY

An example method according to the present invention for activating and/or controlling at least one reversible restraining device may have the advantage that a directional angle is ascertained, at which the vehicle has departed from the roadway, and that the at least one reversible restraining device is activated and/or controlled as a function of the ascertained directional angle. By ascertaining the directional angle at which the vehicle has departed from the roadway, it is advantageously possible to improve the selection and control of the reversible restraining means that are subsequently activated.

By contrast, the example evaluation and control unit for activating and/or controlling at least one reversible restraining device as a function of a danger situation detected ahead of time may have the advantage that the evaluation and control unit detects such a danger situation if an evaluation of the sensor signals concludes that the vehicle has departed from the roadway, the evaluation and control unit ascertaining a directional angle, at which the vehicle has departed from the roadway, and the evaluation and control unit activating and/or controlling the at least one reversible restraining device as a function of the ascertained directional angle.

The example evaluation and control unit according to the present invention for activating and/or controlling at least one reversible restraining device as a function of a danger situation that is detected ahead of time may be used for example in an occupant protection system having at least one sensor unit for detecting accident-relevant information and at least one reversible restraining device.

Specific embodiments of the present invention use the ascertained angular information in particular in order to control the frontal or lateral occupant protection systems accordingly. Depending on the crash case, this makes it possible to use the reversible restraining systems in an optimized and targeted fashion. When including the angular dependency in the decision-making process in the event of a departure from the roadway, the directional angle of the vehicle is taken into consideration, which results between the longitudinal direction of the vehicle and the roadway boundary, e.g., a curb. This yields a first typical range at a directional angle that is smaller than or equal to a specified threshold value of preferably 45°. This range represents a typical longitudinal departure case. A second typical range results at a directional angle that is greater than the specified threshold value of preferably 45°. This range represents a typical perpendicular departure case.

Various evaluation options are available for evaluating the angle. A basic variant continues to rely on the standard crash sensor system and allows for the directional angle, at which the vehicle departs or has departed from the roadway, to be inferred from the corresponding temporal evaluation of the individual events that act on each individual wheel. Alternative specific embodiments include the additional use of a possibly installed tire pressure sensor system for the wheels of the vehicle.

The occupants are protected preventively by the at least one reversible restraining device in the event that the vehicle leaves the roadway. The at least one reversible restraining device includes for example electromotive belt tensioners or seat-based actuators. The at least one reversible restraining device is available for a potential subsequent accident such as a pole crash, a rollover etc., or it unfolds its effect prior to the subsequent accident. This means for example eliminating the belt slack, positioning the occupant, or deploying a reversible cushioning from the vehicle seat or a vehicle cladding part. The example method according to the present invention thus makes it possible to keep the occupants away from intruding structures for as long as possible.

Because of the known directional angle, in the case of a seat having seat-based actuators and an ascertained directional angle smaller than the threshold of preferably 45°, it is possible for example to fill a lateral cushion of the seat or a cushion in a vehicle cladding part, while at an ascertained directional angle larger than the threshold value of preferably 45°, the traditional seat adjustment functions may be triggered and for example a seat height adjustment may be performed.

This furthermore yields the advantage that the existing acceleration-based crash sensors may be used in order to activate the at least one reversible restraining device. Moreover, compared to the related art, the field of action of the at least one reversible restraining device may be substantially extended using standard sensor units.

For detecting angular information, it is particularly advantageous to perform a temporal evaluation of individual events pertaining to the individual wheels of the vehicle. Thus it is possible to ascertain or measure and temporally evaluate for example forces acting on a chassis of the vehicle in order to detect the angular information. The ascertained actions of force are respectively detected on one vehicle wheel or are assigned to one vehicle wheel in order to detect temporal series, in which the successive individual events act on the vehicle so as to obtain information about the directional angle. Additionally, for detecting angular information, it is possible to perform a temporal evaluation of tire pressure information, which is ascertained or measured for example via a tire pressure sensor system. Thus, an event of driving over a curb may be detected as an indication of a departure from the roadway. In the event of driving over a curb, a corresponding time signal of the acceleration measured in the longitudinal direction of the vehicle in a central control unit indicates a very strong signal, which may even exceed signals that are recorded during a crash. The directional angle at which the vehicle departs from the roadway may be inferred from the time sequences of several such signals, which are respectively detected when a vehicle wheel drives over the curb. In contrast to a window integral of the acceleration signal representing a crash, a window integral of the acceleration signal representing the crossing of a curb falls off again after a short time such that an evaluation of the integral of the acceleration signal may yield the detection of a corresponding crossing of a curb. An integral comes to a stop at small values or runs back and may therefore be used also for differentiation. This means very little additional effort in the existing algorithms since generally a characteristic curve must be applied that resembles a typical misuse characteristic curve. Generally, in the case of severe misuse signals, whose threshold is applicable and which are known especially from test drives and which represent a departure from the roadway, the at least one reversible restraining device, in particular in the seat, is activated.

In a development of an example method according to the present invention, restraining devices that protect against lateral impacts are activated if the ascertained directional angle is smaller than or equal to a specified threshold of preferably 45°.

In a further development of the example method according to the present invention, restraining devices that protect against generally frontal impacts are activated if the ascertained directional angle is greater than the specified threshold value of preferably 45°.

A development of the example evaluation and control unit according to the present invention provides for a signal conditioning device, which preprocesses the detected sensor signals prior to evaluation by low-pass filtering and/or squaring and/or integration. The at least one reversible restraining device may be triggered by strong excitations, which arise through oscillations for example, as occur on a rough road surface, or by strong acceleration peaks, as arise when driving over a curb for example. For detecting such events, low-pass filtered acceleration signals and an integral or window integral of the squared or rectified acceleration signal may be used as suitable input variables of the detection algorithm.

In a development of the example occupant protection system according to the present invention, the at least one reversible restraining device includes a belt tensioning function and/or a seat adjustment function and/or a cushion filling function and/or a cushion deployment function and/or a headrest adjustment function.

Advantageous specific embodiments of the present invention are shown in the figures and are described below. In the figures, identical reference symbols indicate components or elements that perform identical or analogous functions.

### BRIEF DESCRIPTION OF THE DRAWINGS

FIG. 1 shows a schematic representation of a vehicle having an occupant protection system of the present invention and an evaluation and control unit of the present invention for implementing an example method in accordance with the present invention for activating and/or controlling at least one reversible restraining device.

FIG. 2 shows a schematic block diagram of an occupant protection system having an example evaluation and control unit of the present invention.

FIG. 3 shows a detail of a road network including a vehicle that departs from a roadway at a directional angle smaller than a specified threshold value of preferably 45°.

FIG. 4 shows another detail of the road network including a vehicle departing from a roadway at a directional angle greater than a specified threshold value of preferably 45°.

FIG. 5 shows a schematic representation of a vehicle wheel as it strikes a curb.

FIG. 6 shows a schematic signal characteristic for representing acceleration signals over time, which are measured in the longitudinal direction of the vehicle.

FIG. 7 shows a schematic signal diagram for representing accelerations a, which are measured in the longitudinal direction of the vehicle, over the reduced velocity (DV).

### DETAILED DESCRIPTION OF EXAMPLE EMBODIMENTS

Active and passive occupant protection systems play an ever greater role in the development of vehicles. To be able to achieve an optimized protective effect, it is necessary to detect an accident very early. The basis for such an accident detection and the activation of the occupant protection systems are sensor systems that include one or multiple sensors, which are combined into one or multiple sensor units for example, and whose signals for detecting a collision with an object and/or for detecting a rollover of the vehicle are evaluated in order subsequently to activate occupant protection devices, including irreversible restraining systems such as airbags or pyrotechnical belt tensioners, and/or reversible restraining systems such as electromotive belt tensioners. Various sensor principles may be used for the individual sensors such as acceleration sensors, pressure sensors, structure-borne noise sensors, piezoelectric sensors and/or optical sensors etc. In addition, predictive sensor systems, conventional so-called precrash sensor systems have video or radar sensors for example in order to detect an imminent contact with an object and to perform an object classification.

A frequent reason for severe to most severe accidents is the departure from the roadway including subsequent secondary collisions. A departure from the roadway frequently involves a crash with respective road installations such as guard rails, lighting poles, signs, posts etc. or with property boundaries such as fences or walls. These secondary collisions may entail very severe injuries for the occupant.

Typically, the standard crash sensor system is already able to register and detect the transition from a more or less smooth road/surface to more or less unpaved terrain. The departure from the roadway usually does not occur at a steep angle, but rather at an obtuse angle, i.e., more or less parallel to the roadway.

In the field of occupant safety in motor vehicles, systems are available, in which belt tensioners are triggered in the event of an emergency braking action or when the vehicle is swerving in order to reduce possibly existing belt slack, i.e., a belt that does not fit tightly. In addition, the standard electric motors for the possibly accelerated comfort seat adjustment in the longitudinal direction, the seat-cushion tilt and the seat-backrest are activated so as to bring the occupant into a safe position for a possible accident. Furthermore, a multi-contour seat or a crash-active seat having a seat back-based and/or seat area-based lateral support may be triggered advantageously so as to improve the lateral support. The vehicle and occupants are thus better prepared in the event of a crash. If the accident does not happen, the activated systems may be reset to their basic state since they are fully reversible. The information for initiating these measures is supplied by sensors of known systems such as a braking assistance system or an ESP system (ESP: electronic stability program), which are able to register critical driving situations such as swerving or emergency braking early.

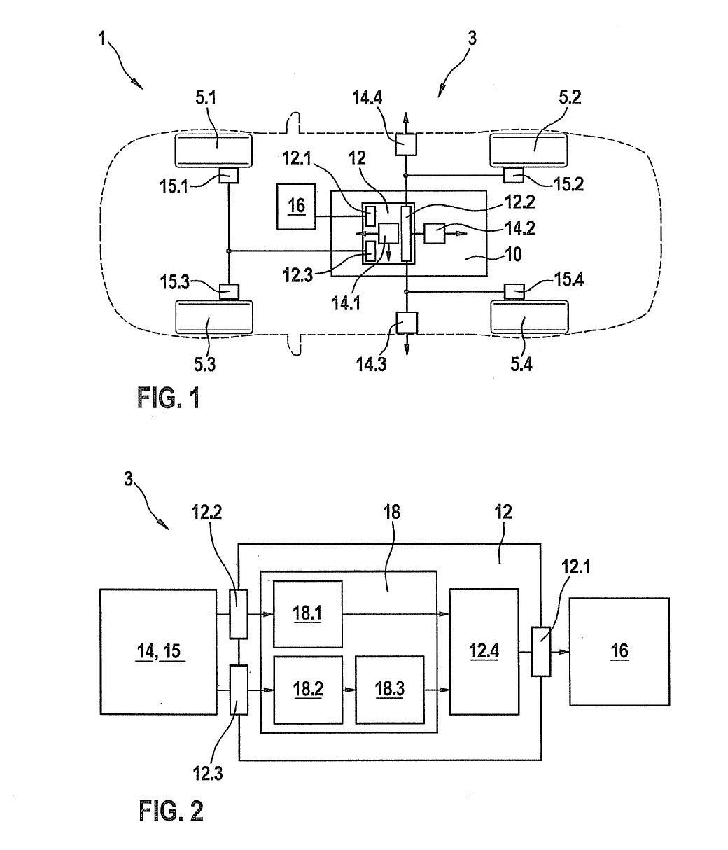

As may be seen from FIGS. 1 and 2, in the shown exemplary embodiment for implementing a method of the present invention for activating and/or controlling at least one reversible restraining device 16 as a function of a danger situation detected ahead of time, a vehicle 1 includes an evaluation and control unit 12. The at least one reversible restraining device 16 is coupled to evaluation and control unit 12 via an interface 12.1. Evaluation and control unit 12 detects the danger situation ahead of time by evaluating sensor signals, which are supplied by multiple sensor units 14, 15 having multiple sensors, of which eight sensors 14.1, 14.2, 14.3, 14.4, 15.1, 15.2, 15.3, 15.4 are shown by way of example. Sensor units 14, 15 or individual sensors 14.1, 14.2, 14.3, 14.4 15.1, 15.2, 15.3, 15.4 are coupled with evaluation and control unit 12 via at least one additional interface 12.2, 12.3.

In addition to evaluation and control unit 12, which is part of a central control unit 10, the associated passenger protection system 1 includes sensor units 14, 15 for detecting accident-relevant information and reversible restraining device 16. A first sensor unit 14 represents a combination of multiple acceleration sensors 14.1, 14.2, 14.3, 14.4, one of which, a sensor 14.1 situated in central control unit 10 for example, detects the accelerations along the longitudinal vehicle axis and along the transverse vehicle axis. Another sensor 14.2, situated for example in central control unit 10, likewise detects the acceleration along the longitudinal vehicle axis. Two additional sensors 14.3, 14.4, situated in the B-pillars for example, detect the accelerations along the transverse axis of the vehicle. A second sensor unit 15 represents a combination of multiple tire pressure sensors 15.1, 15.2, 15.3, 15.4, which respectively detect the pressure in the corresponding vehicle wheel 5.1, 5.2, 5.3, 5.4. Evaluation and control unit 12 detects the danger situation ahead of time by evaluating sensor signals, which are supplied by sensor units 14, 15 or sensors 14.1, 14.2, 14.3, 14.4, 15.1, 15.2, 15.3, 15.4 via interfaces 12.2, 12.3. The at least one reversible restraining device 16 includes for example electromotive belt tensioners and/or seat-based actuators, which are able to perform for example a belt-tensioning function and/or a seat-adjustment function and/or a cushion-filling function and/or a headrest-adjustment function. The occupants may be protected preventively by the at least one reversible restraining device 16 in the event that vehicle 1 departs from roadway 42. The at least one reversible restraining device 16 is available for a potential subsequent accident, or becomes effective prior to the subsequent accident. This means eliminating the belt slack, positioning the occupant, or deploying a reversible cushion. Specific embodiments of the present invention thus makes it possible to keep the occupants away from intruding structures for as long as possible.

As may also be seen from FIG. 2, evaluation and control unit 12 includes a signal conditioning device 18, which preprocesses the detected sensor signals prior to the evaluation by low-pass filtering 18.1 and/or squaring 18.2 and/or integrating 18.3. As an alternative to the shown exemplary embodiment, signal conditioning device 18 may also be situated outside of evaluation and control unit 12, for example as a separate structural unit in control unit 10 or as multiple distributed structural units in sensor units 14, 15 or sensors 14.1, 14.2, 14.3, 14.4, 15.1, 15.2, 15.3, 15.4 and/or in evaluation and control unit 12 and/or in control unit 10. Evaluation and control unit 12 additionally includes a computer and/or logic block 12.4 for performing the evaluation of the sensor signals.

Evaluation and control unit 12 detects such a danger situation if the evaluation of the sensor signals determines that vehicle 1 has departed or is departing from roadway 42, evaluation and control unit 12 ascertaining a directional angle α, at which vehicle 1 has departed or is departing from roadway 42. Evaluation and control unit 12 activates and/or controls the at least one reversible restraining device 16 as a function of the ascertained directional angle α.

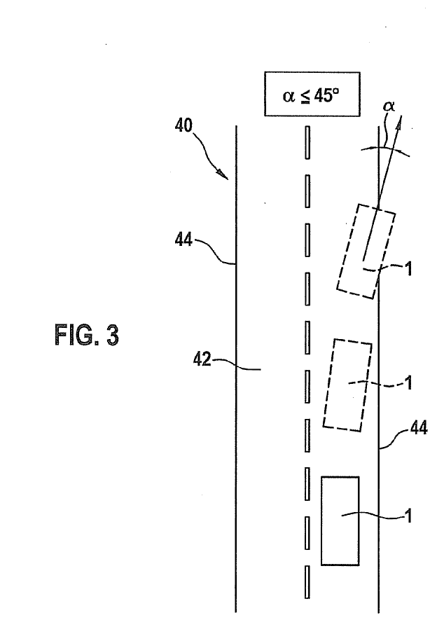

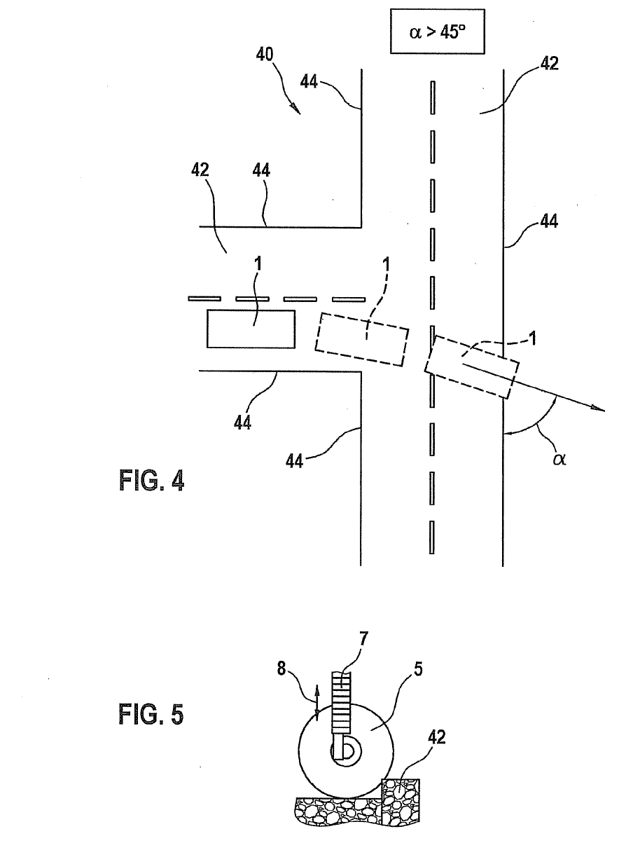

FIGS. 3 and 4 each show a detail of a road network 40 for representing two different scenarios in which vehicle 1 departs from roadway 42 at different directional angles α.

FIG. 3 shows a first scenario for example, in which vehicle 1 departs from roadway 42 at a directional angle α that is smaller than or equal to a specified threshold value of preferably 45°. FIG. 4 shows a second scenario, in which vehicle 1 departs from roadway 42 at a directional angle α that is greater than the specified threshold value of preferably 45°.

For detecting angle information, individual events concerning individual wheels 5, 5.1, 5.2, 5.3, 5.4 of vehicle 1 are temporally evaluated. With reference to FIGS. 5 through 7, an event of driving over a curb is described below as an example of a departure from roadway 42.

FIG. 5 shows for example an action of force on a chassis 7 of vehicle 1 as a vehicle wheel 5 strikes a curb 42, whereby vibrations 8 are produced that may be detected by at least one of sensors 14.1, 14.2, 14.3, 14.4, 15.1, 15.2, 15.3, 15.4 and evaluated by evaluation and control unit 12. Additionally, the event of wheel 5 driving over curb 42 may be detected by an associated tire pressure sensor 15.1, 15.2, 15.3, 15.4 since the tire pressure briefly increases as wheel 5 strikes curb 42.

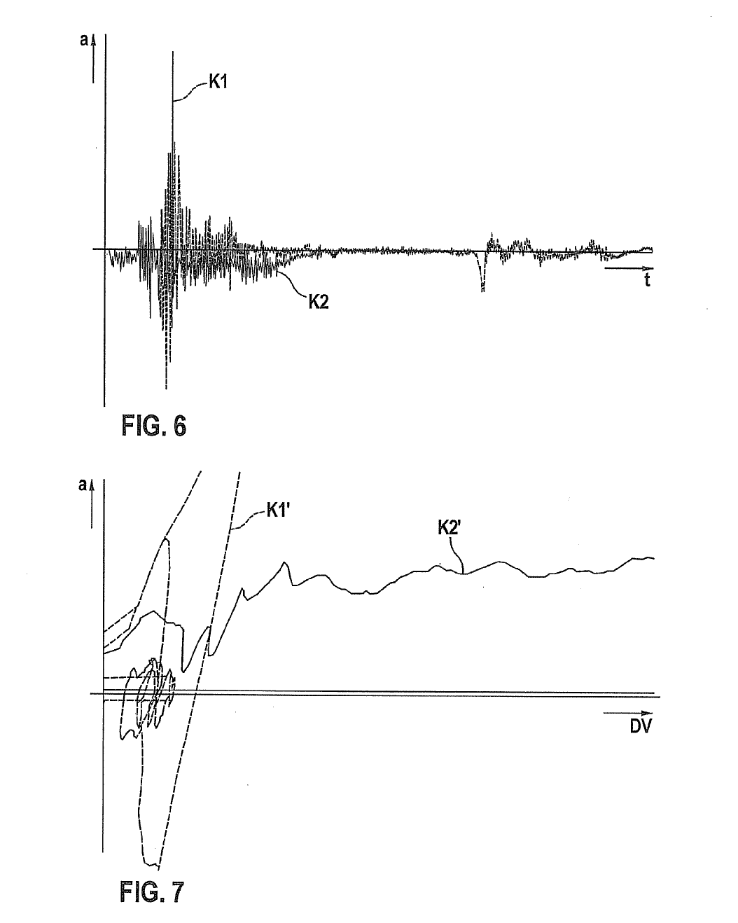

FIG. 6 shows two time signals K1, K2 of the acceleration a measured in the longitudinal direction of the vehicle in the central control unit for a crash K2 and an event of driving over a curb K1. As may be seen from FIG. 6, the event of driving over the curb indicates a very strong signal K1, which even exceeds a signal K2 representing a crash. The event of driving over the curb may also be inferred from plotting the acceleration α over a reduction in velocity DV as shown in FIG. 7. The a/DV diagram from FIG. 7 likewise shows an elevated K1′ signal representing the event of driving over the curb, although the integral of the acceleration K1′ for crossing the curb falls off again after a short time, while the integral of the acceleration K2′ for the crash remains constant. The event of a departure from the roadway may therefore be inferred from the a/DV diagram in FIG. 7. This means very little additional effort in the existing algorithms since generally a characteristic curve must be applied that resembles a typical misuse characteristic curve. Generally, therefore, in the event of severe misuse signals, the at least one reversible restraining device 16, in particular the actuator system in the seat, is activated. Additionally or alternatively, the at least one reversible restraining device 16 may be triggered by a strong excitation such as is produced for example by oscillations caused by a rough road surface or by strong acceleration peaks. Thus, an acceleration signal low-pass filtered in a block 18.1 and the integral or window integral formed in block 18.3 of a signal squared or rectified in block 18.2 may be used as suitable input variables for the detection algorithm in order to detect a departure from roadway 42. According to the present invention, the angle-dependence of the departure from the roadway is included in the decision-making process. For this purpose, the directional angle α is the angle resulting between the longitudinal direction of the vehicle and the roadway boundary 44 such as a curb for example. In the case of a directional angle α that is smaller than or equal to a specified threshold value of preferably 45°, this yields a first typical range representing a typical case of longitudinal departure. A second typical range results at a directional angle α that is greater than the specified threshold value of preferably 45°. This range represents a typical perpendicular departure case.

Various evaluation options are available for evaluating the angle. A basic variant continues to rely on the standard crash sensor system 14 and allows for the directional angle α, at which vehicle 1 departs or has departed from roadway 42, to be inferred from the corresponding temporal evaluation of the individual events that act on each particular wheel 5, 5.1, 5.2, 5.3, 5.4. Alternative specific embodiments include the additional use of a possibly installed tire pressure sensor system 15 for wheels 5, 5.1, 5.2, 5.3, 5.4 of vehicle 1. The angular information may be significant especially for the appropriate triggering of frontal or lateral reversible restraining devices 16. Depending on the crash case, this makes it possible to use the reversible restraining systems 16 in optimized and targeted fashion. On the basis of the known directional angle α it is possible to fill or deploy lateral cushions in the case of a seat having seat-based actuators if a directional angle α is ascertained that is smaller than the threshold value of preferably 45°. In the case of an ascertained directional angle α that is greater than the threshold value of preferably 45°, by contrast, the traditional seat adjustment functions may be triggered and a seat height adjustment may be performed for example.

1-10. (canceled)

11. A method for activating and/or controlling at least one reversible restraining device as a function of a danger situation detected ahead of time, comprising:
detecting a danger situation when an evaluation of sensor signals of at least one sensor determines that the vehicle has departed from a roadway;
ascertaining a directional angle at which the vehicle has departed from the roadway; and
at least one of activating and controlling the at least one reversible restraining device as a function of the ascertained directional angle.

12. The method as recited in claim 11, wherein for detecting angle information, individual events pertaining to individual wheels of the vehicle are temporally evaluated.

13. The method as recited in claim 12, wherein for detecting angular information, ascertained actions of force on a chassis of the vehicle are temporally evaluated.

14. The method as recited in claim 12, wherein for detecting angular information, tire pressure information is temporally evaluated.

15. The method as recited in claim 11, wherein restraining devices that protect against lateral impacts are activated if the ascertained directional angle is smaller than or equal to a specified threshold value of preferably 45°.

16. The method as recited in claim 11, wherein restraining devices that protect against frontal impacts are activated if the ascertained directional angle is greater than the specified threshold value of preferably 45°.

17. An evaluation and control unit for activating and/or controlling at least one reversible restraining device as a function of a danger situation that is detected ahead of time, the at least one reversible restraining device being coupled with the evaluation and control unit via an interface, the evaluation and control unit configured to detect the danger situation ahead of time by evaluating sensor signals that are provided by at least one sensor unit coupled with the evaluation and control unit via at least one additional interface, wherein the evaluation and control unit is configured to detect the danger situation if the evaluation of the sensor signals determines that the vehicle has departed from a roadway, the evaluation and control unit configured to ascertain a directional angle at which the vehicle has departed from the roadway, and the evaluation and control unit configured to at least one of activate and control the at least one reversible restraining device as a function of the ascertained directional angle.

18. The evaluation and control unit as recited in claim 17, further comprising a signal conditioning device, which preprocesses the detected sensor signals prior to the evaluation by at least one of low-pass filtering, squaring, and integrating.

19. An occupant protection system, comprising:
at least one sensor unit to detect accident-relevant information;
at least one reversible restraining device; and
an evaluation and control unit configured to at least one of activate and control the at least one reversible restraining device as a function of a danger situation that is detected ahead of time, the at least one reversible restraining device being coupled with the evaluation and control unit via an interface, the evaluation and control unit configured to detect the danger situation ahead of time by evaluating sensor signals that are provided to the evaluation and control unit by the at least one sensor unit via at least one additional interface, the evaluation and control unit configured to detect the danger situation if evaluation of the sensor signal determines that the vehicle has left a roadway, the evaluation and control unit configured to ascertain a directional angle at which the vehicle has left a roadway, and at least one of activate and control the at least one reversible restraining device as a function of the ascertained directional angle.

20. The occupant protection system as recited in claim 19, wherein the at least one reversible restraining device performs at least one of a belt tensioning function, a seat adjustment function, a cushion filling function, a cushion deployment function, and a headrest adjustment function.
